(19) United States
(12) Patent Application Publication
(10) Pub. No.: US 2006/0187169 A1
(43) Pub. Date: Aug. 24, 2006

(54) Liquid crystal display device having filter to reduce riffle noise

(76) Inventor: Takeshi Okuno, Suwon (KR)

Correspondence Address: CHRISTIE, PARKER & HALE, LLP, PO BOX 7068, PASADENA, CA, 91109-7068, US

(21) Appl. No.: 11/329,814

(22) Filed: Jan. 10, 2006

(30) Foreign Application Priority Data
Feb. 24, 2005 (KR) 2005-15509

(51) Int. Cl. G09G 3/36

(52) U.S. Cl. 345/98

(57) ABSTRACT

An LCD having a filter is provided. The filter is located along a common voltage line Vcom or on a flexible printed circuit board between a regulator and a common voltage generator, thereby filtering a riffle noise occurring in a common voltage electrode and thus enhancing the display performance of an LCD panel.

### CROSS-REFERENCE TO RELATED APPLICATION

This application claims priority to and the benefit of Korean Patent Application No. 2005-15509, filed Feb. 24, 2005, the entire content of which is incorporated herein by reference.

### FIELD OF THE INVENTION

The present invention relates to a liquid crystal display device (LCD), and more particularly, to an LCD having a filter.

### BACKGROUND OF THE INVENTION

An LCD includes a liquid crystal panel formed by filling a uniform space between a thin film transistor substrate and a color filter substrate with liquid crystals. The thin film transistor substrate is formed with a thin film transistor (TFT) used as a switching device, and the color filter substrate is formed with a color filter. Such an LCD has relatively low brightness due to loss of light while passing through the color filter. To reduce the loss of light, a field sequential LCD has been proposed.

The field sequential LCD does not require a color filter, and has a sequential backlight to sequentially emit a red (R) light, a green (G) light and a blue (B) light. In the field sequential LCD, one frame is divided into three sub-frames, and the red, green and blue lights of the respective sub-frames are additively mixed to represent a colored light.

FIG. 1 shows a waveform for driving a conventional field sequential LCD. Displaying a yellow color by the field sequential LCD is described as an example. During the first sub-frame of one frame, an R data voltage of maximum gradation is applied in response to a scan signal, and then the red light is emitted that illuminates the liquid crystal. During the second sub-frame, a G data voltage of maximum gradation is applied, and then the green light is emitted that illuminates the liquid crystal. Lastly, during the third sub-frame, a B data voltage of minimum gradation is applied; in other words, the B data voltage is not applied. Consequently, only the red and green lights are additively mixed in order to create a yellow light.

FIG. 2 is a block diagram of driving units for the conventional field sequential LCD. The driving units include a timing controller 200, a scan driver 210, a data driver 220, a sequential backlight 250, a backlight controller 240, a common voltage generator 230, and a panel 260.

The timing controller 200 supplies control signals to the data driver 220 and the scan driver 210 so as to drive the panel 260 in the red, green and blue sub-frames divided from one frame. In a case where the field sequential LCD is driven at 60 Hz, one frame corresponds to 16.7 ms and thus each sub-frame corresponds to about 5.56 ms as one-third of 16.7 ms. For this reason, the timing controller 200 realigns a video data signal according to red, green and blue colors. Then, the realigned video data signal is supplied as an analog signal to the data driver 220.

The timing controller 200 generates a data control signal and a scan control signal. The data control signal includes a source shift clock signal, a source output enable signal, a polarity reversal signal, and is supplied to the data driver 220. The scan control signal includes a scan start pulse (SSP) signal, a scan shift clock signal, a scan output enable signal, and is supplied to the scan driver 210,

Further, the timing controller 200 controls the backlight controller 240 to sequentially drive a red lamp, a green lamp and a blue lamp when data has been completely supplied to a liquid crystal cell.

The scan driver 210 includes a shift register to sequentially generate the scan signals in response to the SSP signal of the scan control signal output from the timing controller 200, and a level shifter to shift the scan signal to a voltage level suitable for driving the liquid crystal cell. Further, the scan driver 210 supplies the scan signal to the panel 260 through a scan line, thereby selecting a number of pixels provided in the panel 260.

The data driver 220 samples the video data signal in response to the data control signal output from the timing controller 200, latches the sampled video data signal per line, converts the latched video data signal to a gamma voltage, and supplies the video data signal having the gamma voltage as the analog signal to the pixels selected by the scan signal through data lines.

The common voltage generator 230 supplies a common voltage Vcom of the same level to the pixels arranged on the panel 260 through common voltage lines. The panel 260 includes the pixels that are located in areas formed by the intersection of the scan lines and the data lines. Each pixel is coupled to the corresponding data line and the corresponding scan and common voltage lines.

Each pixel includes a switching transistor, the liquid crystal cell and a storage capacitor. The switching transistor is coupled to a corresponding scan line and transmits the data signal from a corresponding data line. The liquid crystal cell has opposite terminals to which the red, green and blue data signals, transmitted through the switching transistor, and the common voltage, transmitted through the common power lines, are applied. The storage capacitor stores the data signal applied to the liquid crystal cell through the switching transistor.

The switching transistor is formed in a region where the data line intersects the scan line. The switching transistor supplies the data signal to the liquid crystal cell in response to the scan signal output from the scan driver 210. The switching transistor includes a source electrode coupled to the data line, and a drain electrode coupled to a pixel electrode of the liquid crystal cell. The switching transistor is a TFT and, therefore, the liquid crystal has a first terminal coupled to the drain electrode of the TFT, and a second terminal coupled to a common voltage electrode.

The pixel electrode is made of transparent and conductive indium tin oxide (ITO). Further, the pixel electrode supplies the data signal from the data driver 220 to the liquid crystal cell when an on-signal is applied to the gate electrode of the TFT. The common voltage electrode that supplies a common voltage Vcom to the liquid crystal cell is also made of ITO.

The storage capacitor Cs is employed to maintain the data signal applied to the pixel electrode for a predetermined period. While the storage capacitor Cs is charged and discharged, the orientation of the liquid crystal cell is varied, thereby adjusting the transmittance of the pixel. In the configuration shown, one terminal of the storage capacitor Cs is coupled to an independent electrode. This terminal can also be coupled to the gate electrode of the TFT. A structure where the storage capacitor Cs has one terminal coupled to the gate electrode of the TFT is called a storage-on-gate structure (not shown).

The sequential backlight 250 shines the red, green and blue lights to the panel 260 in a predetermined sequence. The sequential backlight 250 includes the red lamp, the green lamp, and the blue lamp. Each lamp may be a light emitting diode. The sequential backlight 250 is capable of emitting light of each of the three colors and does not need to create a color by passing a white light through a color filter. Therefore, the field sequential LCD can display various colors without a color filter, thereby enhancing transmittance and brightness. The backlight controller 240 supplies a control signal for driving the sequential backlight 250.

However, in the conventional field sequential LCD, a high frequency riffle noise occurs in the common voltage electrode due to variation of the source voltage. As a result, the common voltages are not uniformly applied to the pixels arranged in the panel 260 and the display performance of the LCD panel deteriorates. Accordingly, a method of filtering the riffle noise through a low-pass filter is needed.

### SUMMARY OF THE INVENTION

The present invention provides a field sequential LCD having a filter for filtering a riffle noise occurring in common voltage electrodes through which a common voltage is applied to a plurality of pixels forming the field sequential LCD panel. The filter is located at a plurality of common voltage lines through which the common voltage is applied to the common voltage electrodes. The filter may be located between a common node of the common voltage lines and a common voltage generator, or between the common voltage generator and a regulator mounted on a flexible printed circuit board.

The filter is used to filter a noise arising at the common voltage generator, at a regulator supplying the common voltage generator, or at some other voltage source. The filter prevents this noise from reaching the common voltage electrode and from occurring in the common voltage electrodes.

In an exemplary embodiment of the present invention, an LCD includes a panel having a plurality of pixels formed in regions in which a plurality of scan lines for supplying scan signals from a scan driver intersect a plurality of data lines for supplying data signals from a data driver, a common voltage generator for supplying a common voltage to the plurality of pixels provided in the panel, and a filter for filtering a riffle noise occurring in a common voltage electrode, located on a plurality of common voltage lines through which the common voltage is supplied from the common voltage generator to the plurality of pixels.

In another exemplary embodiment of the present invention, an LCD includes a panel having a plurality of pixels formed in regions in which a plurality of scan lines for supplying scan signals from a scan driver intersect a plurality of data lines for supplying data signals from a data driver, a common voltage generator for supplying a common voltage to the plurality of pixels, and a filter for filtering a riffle noise occurring in a common voltage electrode, that is interposed between the common voltage generator and a common node of a plurality of common voltage lines through which the common voltage is supplied from the common voltage generator to the plurality of pixels.

In still another exemplary embodiment of the present invention, an LCD includes a panel having a plurality of pixels formed in regions in which a plurality of scan lines for supplying scan signals from a scan driver intersect a plurality of data lines for supplying data signals from a data driver, a common voltage generator for supplying a common voltage to the plurality of pixels provided in the panel, a timing controller for supplying control signals to drive the panel to the data driver and the scan driver, a flexible printed circuit board for coupling the panel to the timing controller, and a filter for filtering a riffle noise occurring in a common voltage electrode.

According to embodiments of the present invention, a field sequential LCD including a filter is presented where the filter is located in various locations along the circuit of common voltage lines through which a common voltage is applied to pixels forming the field sequential LCD panel. The filter is a low-pass filter attenuating frequencies of above a cut-off frequency. A number of filters may be located along each of the common voltage lines leaving the common voltage generator. Alternatively, the filter may be located, between a common voltage generator and a common node of the common voltage line going to the pixels of the display, or between a regulator mounted on a flexible printed circuit board and the common voltage generator. Thus, the common voltages of the same level are uniformly applied to the pixels arranged in the panel, enhancing the performance of the LCD panel.

### BRIEF DESCRIPTION OF THE DRAWINGS

FIG. 1 shows a waveform for driving a conventional field sequential LCD.

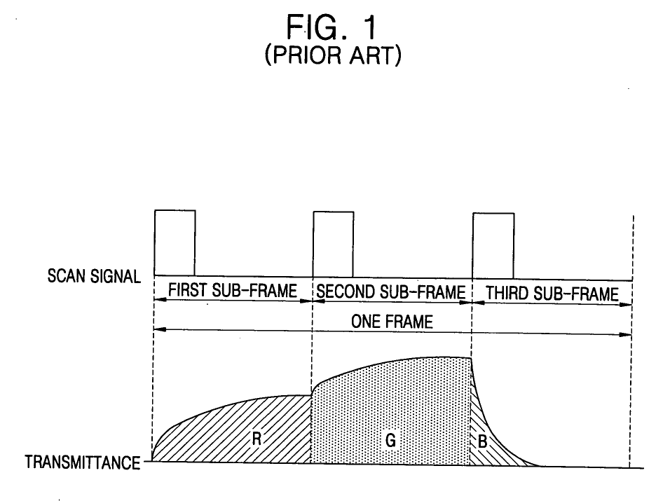

FIG. 2 is a block diagram of driving units for the conventional field sequential LCD.

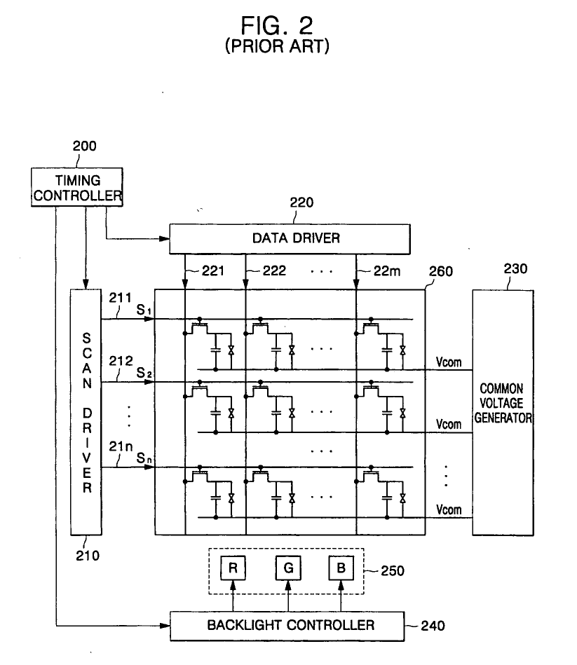

FIG. 3A is a block diagram of driving units for a field sequential LCD according to a first embodiment of the present invention.

FIG. 3B is a circuit diagram of a switched-capacitor filter derived from an active resistor-capacitor (RC) filter.

FIG. 4 is a block diagram of driving units for a field sequential LCD according to a second embodiment of the present invention.

FIG. 5 is a block diagram of driving units for a field sequential LCD according to a third embodiment of the present invention.

### DETAILED DESCRIPTION

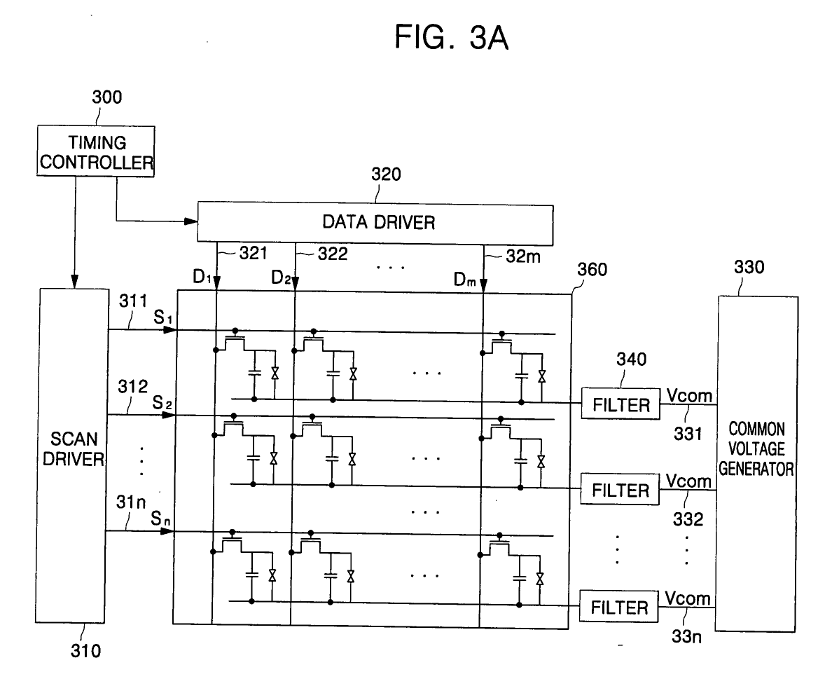

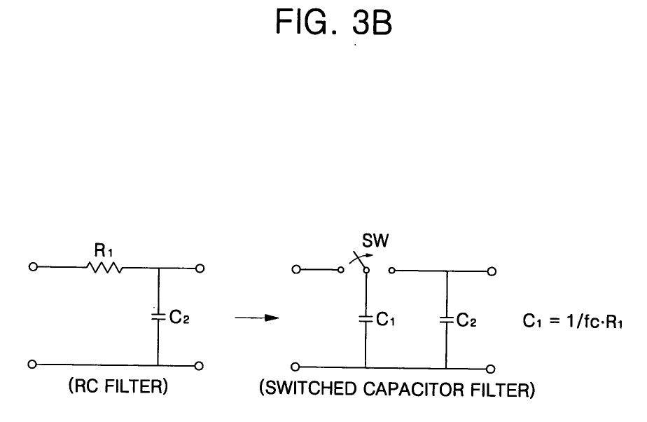

FIG. 3A is a block diagram of driving units for a field sequential LCD according to a first embodiment of the present invention. The driving units for the field sequential LCD of the first embodiment include a timing controller 300, a data driver 320, a scan driver 310, a panel 360, a common voltage generator 330, and a filter 340.

The timing controller 300 supplies control signals to the data driver 320 and the scan driver 310 so as to drive the panel 360 in the red, green and blue sub-frames divided from one frame. Here, the timing controller 300 realigns a video data signal according to red, green and blue colors, and then supplies the realigned video data signal as a digital signal to the data driver 320.

The data driver 320 samples the video data signal in response to the control signal output from the timing controller 300, latches the sampled video data signal per line, converts the latched video data signal to a gamma voltage, and supplies the video data signal, having the gamma voltage, as the analog signal to pixels provided in the panel 360 through a number of data lines.

The scan driver 310 includes a shift register to sequentially generate scan signals in response to a SSP signal of a scan control signal output from the timing controller 300, and a level shifter to shift the scan signal to a voltage level suitable for driving a liquid crystal cell. Further, the scan driver 310 supplies the scan signal to the panel 360 through a scan line in order to select the pixels.

The common voltage generator 330 supplies a common voltage Vcom of the same level to the pixels arranged on the panel 360 through common voltage lines.

The panel 360 includes the pixels coupled to the scan lines 311 through 31n, the data lines 321 through 32m, and the common voltage lines 331 through 33n.

Each pixel includes a switching transistor coupled to a corresponding scan line 31i and transmitting the data signal from a corresponding data line 32j. The liquid crystal cell has opposite terminals to which the red, green and blue data signals and the common voltage are applied. The data signals are transmitted through the switching transistor and the common voltages are transmitted through the corresponding common voltage line 33i. A storage capacitor stores the data signal applied to the liquid crystal cell through the switching transistor.

The field sequential LCD includes a sequential backlight (not shown), and a backlight controller (not shown) controlling the sequential backlight. The sequential backlight includes a red lamp, a green lamp, and a blue lamp, and sequentially emits red, green and blue lights to the panel 360 based on a control signal of the backlight controller. Here, each lamp may be a light emitting diode. Further, the backlight controller sequentially supplies the control signals to the sequential backlight so as to sequentially drive the sequential backlight based on the control signal output from the timing controller.

The filter 340 is provided on each of the common voltage lines 331 through 33n and interposed between the panel 360 and the common voltage generator 330. Thus, the filter 340 filters off a high frequency riffle noise occurring in a common voltage electrode and allows the pixels arranged in the panel 360 to receive the common voltage of the same level. In one embodiment, the filter 340 operates as a low-pass filter having a cut-off frequency of 500 kHz. This low-pass filter may be fabricated by a low temperature poly silicon (LTPS) technique.

Alternatively, the low-pass filter can be replaced with an active resistor-capacitor (RC) filter or a switched-capacitor filter (SCF). FIG. 3B is a circuit diagram of an SCF derived from an active RC filter. A resistor R1 of the active RC filter can be replaced by a switched capacitor C1. The capacitance of the switched capacitor C1 of the SCF is calculated according to equation (1) that follows.

$$C 1 = \frac{1}{fcR 1} \qquad ( 1 )$$

In equation (1), fc is the cut-off frequency of the resulting low-pass filter.

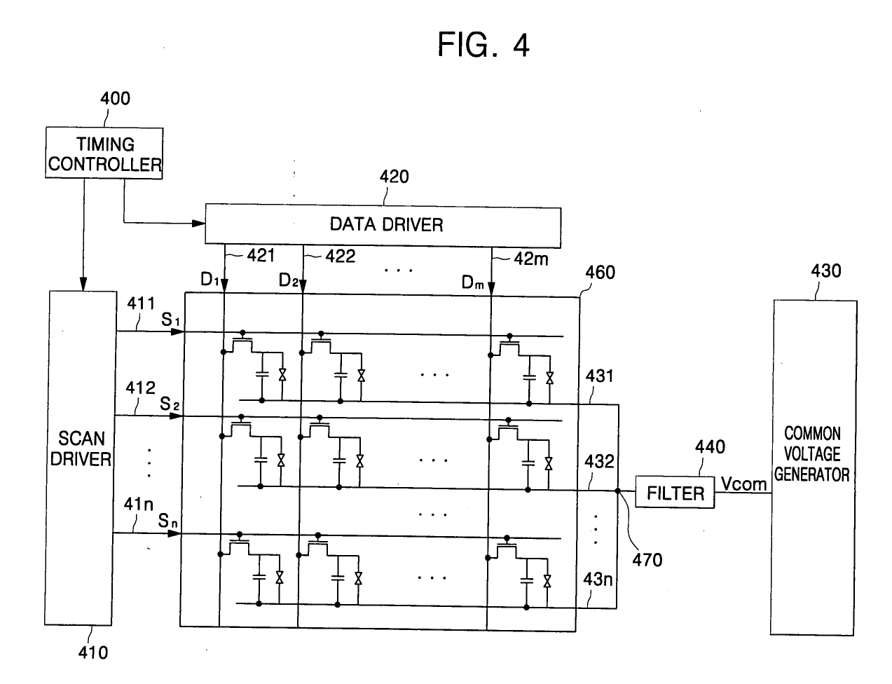

FIG. 4 is a block diagram of driving units for a field sequential LCD according to a second embodiment of the present invention. The driving units for the field sequential LCD of the second embodiment include a timing controller 400, a data driver 420, a scan driver 410, a panel 460, a common voltage generator 430, and a filter 440. Further, the field sequential LCD includes a sequential backlight (not shown) and a backlight controller (not shown) controlling the sequential backlight.

The timing controller 400, the data driver 420, the scan driver 410, the panel 460, the common voltage generator 430, the sequential backlight and the backlight controller are similar to those of the first embodiment, and their description is therefore omitted.

The filter 440 is located between the common voltage generator 430 and a common node 470 of the common voltage lines 431 through 43n through which a common voltage Vcom is applied to the pixels of the panel 460. The filter 440 filters off a high frequency riffle noise occurring in the common voltage electrode and uniformly supplies a common voltage of the same level to the pixels arranged in the panel 460. In one embodiment, the filter 440 operates as a low-pass filter having a cut-off frequency of 500 kHz. This low-pass filter may be fabricated by a LTPS technique.

Alternatively, the low-pass filter can be replaced with an active RC filter or an SCF. In the case where the low-pass filter has a resistance of R1 and a cut-off frequency of fc, the capacitance of the switched capacitor C1 of the SCF, shown in FIG. 3b, is obtained from equation (1) presented above.

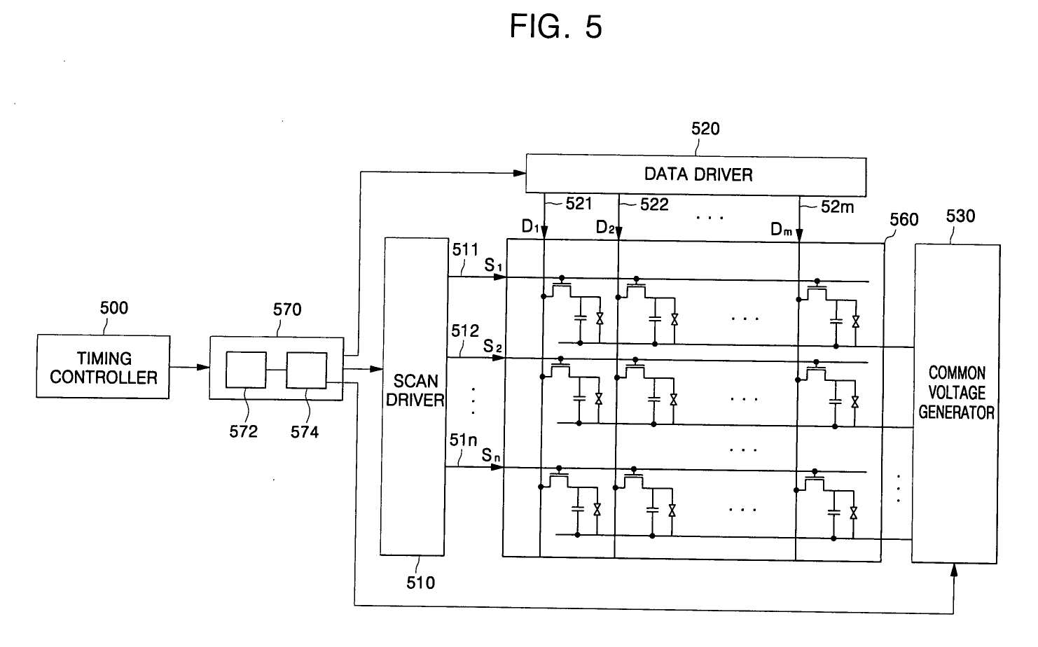

FIG. 5 is a block diagram of driving units for a field sequential LCD according to a third embodiment of the present invention. The driving units for the field sequential LCD of the third embodiment include a timing controller 500, a data driver 520, a scan driver 510, a panel 560, a common voltage generator 530, and a flexible printed circuit board 570.

The scan driver 510, the data driver 520, the timing controller 500, the common voltage generator 530, and the panel 560 are similar to those of the first embodiment, and their description is omitted.

The flexible printed circuit board 570 includes a regulator 572, and a filter 574. The flexible printed circuit board 570 supplies control signals from the timing controller 500 to the scan driver 510 and the data driver 520, thereby driving the panel 560. Further, the flexible printed circuit board 570 includes a backlight controller (not shown).

The backlight controller sequentially supplies the control signals to a sequential backlight (not shown) to drive the sequential backlight. The sequential backlight includes a red lamp, a green lamp and a blue lamp, and sequentially emits red, green and blue lights to the panel 560 based on a control signal output from the backlight controller. Each lamp may be a light emitting diode.

The regulator 572 is provided on the flexible printed circuit board 570, and supplies a voltage for driving the panel 560. The filter 574 is interposed between the common voltage generator 530 and the regulator 572. Thus, the filter 574 filters off a high frequency riffle noise occurring in the common voltage electrode and uniformly supplies a common voltage of the same level to the pixels arranged in the panel 560. Accordingly, in one embodiment, the filter 574 operates as a low-pass filter having a cut-off frequency of 500 kHz.

Alternatively, the low-pass filter can be replaced with an active RC filter or an SCF. In the case where the low-pass filter has a resistance of R1 and a cut-off frequency of fc, the capacitance of the switched capacitor C1 of the SCF, shown in FIG. 3B is obtained from equation (1) presented above.

Although the present invention has been described with reference to certain exemplary embodiments, it will be understood by those skilled in the art that a variety of modifications and variations may be made to the present invention without departing from the spirit or scope of the present invention defined in the appended claims, and their equivalents.

What is claimed is:

1. A liquid crystal display (LCD) comprising:
a plurality of scan lines for supplying scan signals from a scan driver;
a plurality of data lines for supplying data signals from a data driver;
a panel having a plurality of pixels formed in regions where the plurality of scan lines intersect the plurality of data lines, the plurality of pixels receiving the scan signals and the data signals;
a common voltage generator for supplying a common voltage to the plurality of pixels through a plurality of common voltage lines; and
a filter provided at the plurality of common voltage lines for filtering a riffle noise arising at the common voltage generator.

2. The LCD of claim 1, wherein the filter is interposed between the panel and the common voltage generator.

3. The LCD of claim 2, wherein the filter serves as a low-pass filter.

4. The LCD of claim 3, wherein the filter is fabricated by a low temperature poly silicon technique.

5. The LCD of claim 2, wherein the filter includes one of an active RC filter and a switched-capacitor filter.

6. The LCD of claim 2, wherein the filter has a cut-off frequency of 500 kHz.

7. The LCD of claim 1, further comprising a backlight having red, green and blue light emitting diodes adapted to be driven in sequence.

8. A liquid crystal display (LCD) comprising:
a plurality of scan lines for supplying scan signals from a scan driver;
a plurality of data lines for supplying data signals from a data driver;
a panel having a plurality of pixels formed in regions where the plurality of scan lines intersect the plurality of data lines, the plurality of pixels receiving the scan signals and the data signals;
a common voltage generator for supplying a common voltage to the plurality of pixels in the panel through a plurality of common voltage lines, the plurality of common voltage lines forming a common node between the common voltage generator and the panel; and
a filter interposed between the common voltage generator and the common node for filtering a riffle noise arising at the common voltage generator.

9. The LCD of claim 8, wherein the filter serves as a low-pass filter.

10. The LCD of claim 9, wherein the filter is fabricated by a low temperature poly silicon technique.

11. The LCD of claim 9, wherein the filter includes one of an active RC filter and a switched-capacitor filter.

12. The LCD of claim 9, wherein the filter has a cut-off frequency of 500 kHz.

13. The LCD of claim 12, further comprising a backlight having red, green and blue light emitting diodes adapted to drive in sequence.

14. A liquid crystal display (LCD) comprising:
a plurality of scan lines for supplying scan signals from a scan driver;
a plurality of data lines for supplying data signals from a data driver;
a panel having a plurality of pixels formed in regions where the plurality of scan lines intersect the plurality of data lines, the plurality of pixels receiving the scan signals and the data signals;
a common voltage generator for supplying a common voltage to the plurality of pixels;
a timing controller for supplying control signals to the data driver and the scan driver, the control signals supplied to the data driver for driving the panel; and
a flexible printed circuit board for coupling the timing controller to the panel, the flexible printed circuit board having a filter for filtering a riffle noise occurring at a common voltage electrode.

15. The LCD of claim 14, further comprising a regulator provided on the flexible printed circuit board and supplying a voltage for driving the panel.

16. The LCD of claim 15, wherein the filter serves as a low-pass filter.

17. The LCD of claim 16, wherein the filter includes one of an active RC filter and a switched-capacitor filter.

18. The LCD of claim 16, wherein the filter has a cut-off frequency of 500 kHz.

19. The LCD of claim 14, further comprising a backlight having red, green and blue light emitting diodes adapted to being driven in sequence.

20. The LCD of claim 14, wherein each of the plurality of pixels includes:
a switching transistor coupled to the scan lines and the data lines;
a capacitor coupled to the switching transistor for storing the data signal; and
a liquid crystal cell coupled to a node formed by the switching transistor and the capacitor, the liquid crystal cell also coupled to a common voltage electrode, the common voltage electrode coupled to one of the common voltage lines for receiving the common voltage from the common voltage generator.
